(19) United States
(12) Patent Application Publication
(10) Pub. No.: US 2026/0101099 A1
(43) Pub. Date: Apr. 9, 2026

(54) CAMERA VIEW GUIDE AND VEHICLE INCLUDING THE SAME

(71) Applicants: Hyundai Motor Company, Seoul (KR); Kia Corporation, Seoul (KR)

(72) Inventors: Sung Hwan Jun, Hwaseong-si (KR); Dong Hyuk Jeong, Hwaseong-Si (KR); Seok Ju Yeom, Hwaseong-Si (KR); Joo Young Song, Hwaseong-Si (KR); Se Young Park, Hwaseong-Si (KR); Kyoung Jun Kim, Hwaseong-Si (KR)

(21) Appl. No.: 19/227,821

(22) Filed: Jun. 4, 2025

(30) Foreign Application Priority Data
Oct. 7, 2024 (KR) 10-2024-0135816

(51) Int. Cl. H04N 23/54; G03B 11/04; G03B 30/00

(52) U.S. Cl. CPC H04N 23/54; G03B 11/045; G03B 30/00

(57) ABSTRACT

According to an embodiment of the present disclosure, a camera light shield may include: a camera mount; a bottom plate comprising a top edge connected to a lower portion of the camera mount; and a pair of side plates each connected to the bottom plate and a side portion of the camera mount. The bottom plate may slope down from the top edge to a bottom edge of the bottom plate. A plurality of steps may be formed on a sloped surface of the bottom plate.

### CROSS-REFERENCE TO RELATED APPLICATIONS

The present application claims priority to Korean Patent Application No. 10-2024-0135816, filed on Oct. 7, 2024, the entire content of which is incorporated herein for all purposes by this reference.

### TECHNICAL FIELD

The present disclosure relates to vehicle sensors, and more specifically to vehicle-mounted cameras.

### BACKGROUND

An image capturing or recording device, such as a camera, may be mounted in or built into a vehicle during the manufacturing process. Such built-in cameras (e.g., factory-installed cameras) can improve product value by offering ease of use and out-of-the-box vehicle imaging experience for every driver.

The built-in cameras may record and store images of the surrounding environment of a vehicle during a driving or parking operation. In recent years, the built-in cameras are increasingly being used for obtaining data (e.g., raw data) for realizing an advanced driver assistance system (ADAS) technology.

As part of the ADAS technologies, lane keep assist (LKA) may warn a driver when a vehicle swerves or deviates from a lane during a drive so as to keep the vehicle within a designated driving lane.

A light shield may be optionally mounted in front of a built-in camera to improve the accuracy of the LKA driving lane recognition by attenuating or preventing glares and reflections on the windshield glass, such as light reflected from the vehicle dashboard.

### SUMMARY

The present disclosure is intended to relieve or solve limitations of at least some implementations.

The present disclosure provides an improved light shield structure that reduces (e.g., minimizes) a light reflection phenomenon.

According to one or more example embodiments of the present disclosure, a camera light shield may include: a camera mount, and a bottom plate including a top edge connected to a lower portion of the camera mount. The bottom plate may slope down from the top edge to a bottom edge of the bottom plate. A plurality of steps may be formed on a sloped surface of the bottom plate. The camera light shield may further include a pair of side plates each connected to the bottom plate and a side portion of the camera mount.

A quantity of the plurality of steps may be between 12 and 20.

Surfaces of the plurality of steps may be matte-finished.

Each step of the plurality of steps may have a height between 2.0 mm and 3.0 mm.

Each step of the plurality of steps may be formed in a shape of a convex arc with respect to the camera mount.

A cross-section of each step of the plurality of steps may include lines meeting at an obtuse angle.

Surfaces of the plurality of steps may be matte-finished. A quantity of the plurality of steps may be between 12 and 20. Each step of the plurality of steps may have a height between 2.0 mm and 3.0 mm. Each step of the plurality of steps may be formed in a shape of a convex arc with respect to the camera mount. A cross-section of each step of the plurality of steps may include lines meeting at an obtuse angle.

The camera light shield may include a back wall disposed at a back of the camera light shield, the back wall having an aperture therethrough. The bottom plate may include a front edge and a back edge that are connected to a pair of side edges. The bottom plate may share each side edge of the pair of side edges with a corresponding side wall of a pair of side walls. Each side wall of the pair of side walls may connect to a different side of the back wall at an obtuse angle. The back edge of the bottom plate may connect to the back wall. The front edge may be greater in length than the back edge. A cascading ripple texture may be formed on the bottom plate. The cascading ripple texture may include a plurality of arcs having a forward concavity toward the front edge and away from the aperture.

According to one or more example embodiments of the present disclosure, a vehicle may include a camera light shield. The camera light shield may include: a camera mount, and a bottom plate including a top edge connected to a lower portion of the camera mount. The bottom plate may slope down from the top edge to a bottom edge of the bottom plate. A plurality of steps may be formed on a sloped surface of the bottom plate. The camera light shield may further include a pair of side plates each connected to the bottom plate and a side portion of the camera mount. The vehicle may further include a camera mounted at the camera mount of the camera light shield.

A quantity of the plurality of steps may be between 12 and 20.

Surfaces of the plurality of steps may be matte-finished.

Each step of the plurality of steps may have a height between 2.0 mm and 3.0 mm.

Each step of the plurality of steps may be formed in a shape of a convex arc with respect to the camera mount.

A cross-section of each step of the plurality of steps may include lines meeting at an obtuse angle.

The camera light shield may include a back wall disposed at a back of the camera light shield, the back wall having an aperture therethrough. The bottom plate may include a front edge and a back edge that are connected to a pair of side edges. The bottom plate may share each side edge of the pair of side edges with a corresponding side wall of a pair of side walls. Each side wall of the pair of side walls may connect to a different side of the back wall at an obtuse angle. The back edge of the bottom plate may connect to the back wall. The front edge may be greater in length than the back edge. A cascading ripple texture may be formed on the bottom plate. The cascading ripple texture may include a plurality of arcs having a forward concavity toward the front edge and away from the aperture.

According to one or more example embodiments of the present disclosure, a camera light shield may include: a back wall disposed at a back of the camera light shield, the back wall having an aperture therethrough; a pair of side walls, each side wall of the pair of side walls connecting to a different side of the back wall at an obtuse angle; and a bottom plate including a front edge and a back edge that are connected to a pair of side edges. The bottom plate may share each side edge of the pair of side edges with a corresponding side wall of the pair of side walls. The back edge of the bottom plate may connect to the back wall. The front edge may be greater in length than the back edge. A cascading ripple texture may be formed on the bottom plate. The cascading ripple texture may include a plurality of arcs having a forward concavity toward the front edge and away from the aperture.

### BRIEF DESCRIPTION OF THE DRAWINGS

FIG. 1 is a flowchart illustrating an experiment process for deriving improved design conditions of a light shield.

FIG. 2 is a perspective view showing a shape of an example light shield.

FIG. 3 is an example table for selecting a primary design factor.

FIG. 4 is a view illustrating different levels of example incident angles of a light source as a noise factor.

FIG. 5 is a table showing 18 example combinations of noise factors.

FIG. 6 is a table showing a L9 orthogonal array table including the primary design factor and the noise factor.

FIG. 7 is a flowchart illustrating a process of performing an experiment and analyzing results of the experiment based on the orthogonal array table.

FIG. 8 is a view showing some images obtained for each experiment condition.

FIG. 9 is a view showing a gray-scale (brightness) histogram calculated by analyzing the images of FIG. 8.

FIGS. 10A and 10B are orthogonal arrays tables showing brightness values for each image of a matte finish light shield.

FIGS. 11A and 11B are orthogonal array tables showing brightness values for each image of a glossy finish light shield.

FIG. 12 is a table showing a process of analyzing results of an experiment using the orthogonal array table.

FIG. 13 is a table showing a signal-to-noise (SN) ratio and a mean value for each combination under matte and glossy conditions.

FIG. 14 is a view showing results obtained by analyzing an interaction between the primary design factors.

FIGS. 15A, 15B, 16A, and 16B are tables and graphs showing SN ratios and mean values for each level of the primary design factors.

FIGS. 17A and 17B are tables showing SN ratios and mean values of factor

D for matte and glossy materials.

FIGS. 18A and 18B are tables showing SN ratios and mean values of factor D under outward and inward reflection angle conditions.

FIG. 19 is a table showing a deviation in SN ratios and mean values for each primary design factor.

FIG. 20 is a table showing SN ratios and mean values obtained based on orthogonal array experiment conditions (darkroom experiment conditions) for at least some implementations of a light shield, an improved (e.g., optimized) sample 1, and an optimal sample 2.

FIG. 21 are images photographed by a front camera by mounting a light shield mounted on a vehicle for at least some implementations of a light shield, an improved (e.g., optimized) sample 1, and an optimal sample 2.

FIG. 22 is a view showing histograms obtained from the images of FIG. 21.

### DETAILED DESCRIPTION

The present disclosure is described through one or more example embodiments. However, this does not limit the present disclosure within any specific embodiments and it should be understood that the present disclosure covers all the modifications, equivalents, and replacements within the idea and technical scope of the present disclosure.

In this specification, the suffixes “module” and “unit” are used merely for nominal distinction between components and should not be interpreted as implying that the components are physically or chemically separated or that they can be separated.

It will be understood that although the terms of “first” and “second” are used herein to describe various elements, these elements should not be limited by these terms.

These terms may be used solely to differentiate one component from another in name, and their sequential meanings are understood through the context of the description rather than by the names themselves.

The term “and/or” is used to include all possible combinations of the listed items. For example, “A and/or B” includes all three cases of “A”, “B”, and “A and B”.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

It will also be understood that when an element is referred to as being “connected to” or “engaged with” another element, it can be directly connected to the other element, or intervening elements may also be present.

In the following description, the technical terms are used only for explaining one or more example embodiment while not limiting the present disclosure.

The terms of a singular form may include plural forms unless referred to the contrary.

The meaning of ‘include’ or ‘comprise’ specifies a property, a region, a fixed number, a step, a process, an element and/or a component but does not exclude other properties, regions, fixed numbers, steps, processes, elements and/or components.

Unless terms used in the present disclosure are defined differently, the terms may be construed as meaning known to those skilled in the art.

Terms such as terms that are generally used and have been in dictionaries should be construed as having meanings matched with contextual meanings in the art. In this description, unless defined clearly, terms are not ideally, excessively construed as formal meanings.

Also, the terms unit, control unit, control device, or controller are widely used to name devices that control specific functions and do not refer to a generic functional unit.

Also, the devices denoted by the names may include a communication device that communicates with another controller or sensor to control the corresponding function, a computer-readable recording medium that stores an operation system, a logic command, and input/output information, and at least one processor that performs determinations, decisions, and calculations required for function control.

On the other hand, the processor may include semiconductor integrated circuits and/or electronic elements that perform at least one or more of comparisons, determinations, calculations, and decisions to achieve programmed functions.

For example, the processor may be a computer, a microprocessor, CPU, ASIC, an electronic circuitry (logic circuits), or a combination thereof.

Also, the computer readable recording medium (or memory) includes all sorts of data storage devices that store computer readable data.

For example, the computer readable recording medium may include at least one of a flash memory type, hard disk type, micro type, card type (e.g., secure digital (SD) card) or eXtream digital (XD) type memory and a random access memory (RAM), static RAM (SRAM), read-only memory (ROM), programmable ROM (PROM), electrically erasable PROM (EEPROM), magnetic RAM (MRAM), magnetic disk, or optical disk type memory.

These recording media may be electrically connected to the processor, and the processor may read data from and write data to the recording media.

The recording media and the processor may be integrated with each other or physically separated from each other.

Hereinafter, one or more example embodiments of the present disclosure will be described with reference to the accompanying drawings.

A light shield may be an apparatus that blocks or attenuates light. In particular, a light shield may be mounted at a position approximate to (e.g., at, adjacent to, on, near, etc.) a camera to block or attenuate at least some light (e.g., stray light) from reaching or entering an aperture (e.g., a lens) of a camera. The light shield may also variously be referred to as a view guide, a shield, a lens shield, a shroud, a light shroud, a lens shroud, a shade, a light shade, a lens shade, a hood, a light hood, a lens hood, etc. The light shield may include one or more sides or walls that are made of an opaque material (e.g., plastic, metal, resin, etc.) that can, for example, block, attenuate, reflect, or refract light. The light shield may form a part of a housing, an enclosure, or a mount for the camera.

The present disclosure uses a design for six sigma (DFSS) robust method using an orthogonal array table to find improved (e.g., optimized) design specifications of a light shield that reduces light reflection.

When manufacturing a product, various design factors may determine specifications of the product, and each of the design factors may have various levels. The DFSS robust method is an experimental method capable of finding an improved (e.g., optimized) combination by analyzing a trend thereof by using only a portion of the combinations instead of conducting experiments by using all combinations for each level and for each factor.

A light shield may include a bottom plate that extends outward in a trapezoidal triangular or shape from the mounted location of the lens of the camera. The light shield may also include side plates formed on either side of an inclined surface of the trapezoidal (or triangular) bottom plate. The bottom plate may have a stair-like structure that inclines gradually downward from the mounted position of the camera.

However, depending on the variations on the detailed specifications of the light shield, light may be reflected off the surface (e.g., the surface of the bottom plate) of the light shield may create undesirable visual artifacts, such as blurring, ghosting, flaring, etc. if the light source happens to satisfy a specific condition, such as an angle of incidence.

The present disclosure illustrates, through one or more example embodiments, an improved light shield having reduced or eliminated light reflection, and a method of designing and manufacturing such a device.

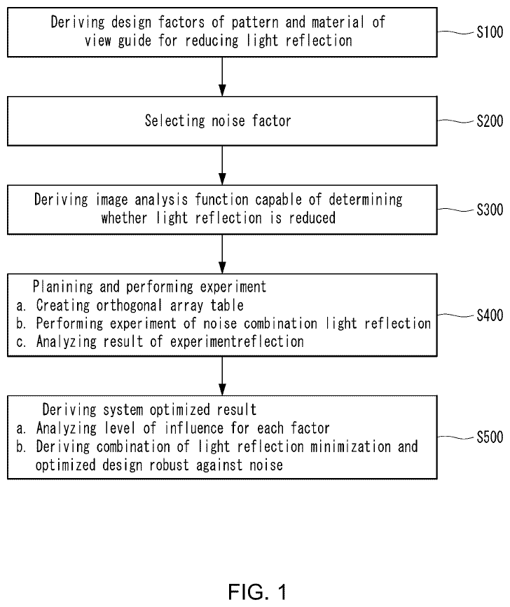

FIG. 1 is a flowchart illustrating a process for deriving improved design conditions of a light shield.

Design factors (e.g., parameters, conditions, etc.) of a light shield for reducing light reflection may be derived in step S100.

For example, a pattern and a material for a base plate 200 may be considered to be factors that influence light reflection in the light shield. One of more such factors may be adopted (e.g., determined) as design factors.

A noise factor may be selected (e.g., determined) as an environmental factor in step S200.

After each factor is selected, an image analysis function, capable of determining whether light reflection is reduced, may be derived (e.g., determined) in step S300.

Image data may be obtained by installing the light shield manufactured based on a specific combination of the design factors in a vehicle and creating an environment based on the selected noise factor, and a test result may be analyzed through the image analysis function in step S400.

The test result may be analyzed to determine how much each factor influences (e.g., contributes to) light reflection. An improved (e.g., optimized) design combination that reduces (e.g., minimizes) light reflection and is robust against noise is derived in step S500.

Hereinafter, each experiment step will be described in detail.

The steps S100 and S200 of selecting the design factors and the noise factor will be described.

In this example experiment, a primary design factor related to a shape (e.g., a texture, a structure, etc.) of a surface of a bottom plate 200 of the light shield and a secondary design factor related to a material of the surface may be selected.

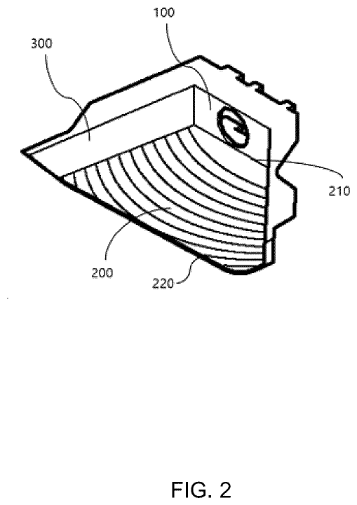

FIG. 2 is a perspective view showing a shape of an example light shield. The light shield may, for example, be installed on an inner surface of a windshield (e.g., a front window glass or a back window glass), such that the camera that is mounted on the light shield may face the exterior of the vehicle.

The light shield may include a camera mount 100 to which a camera (e.g., a front camera) may be mounted. The light shield may also include a bottom plate 200. The bottom plate 200 may have a polygonal shape (e.g., a trapezoid, a triangle, a rectangle, a square, etc.). The bottom plate 200 may have a top edge (also referred to as a top end, an inner edge, an inner end, or a first edge) 210 and a bottom edge (also referred to as a bottom end, an outer edge, an outer end, or a second edge) 220. The bottom edge 220 may be greater in width than the top edge 210, thereby giving the bottom plate 200 a trapezoidal shape. The top edge 210 may connect to (e.g., meet at) a lower portion (e.g., a lower end) of the camera mount 100. The light shield may further include a pair of side plates (also referred to as walls, side walls, wall plates, or side wall plates) 300 that connect to (e.g., meet at) the bottom plate 200 and the camera mount 100. Each of the side plates 300 may be connected to an inclined side of the bottom plate 200 and a side portion of the camera mount 100. The camera mount 100 may include, for example, an aperture through which the camera may receive light (e.g., obtain image) The camera mount 100 may also include a cavity (e.g., a chamber, a space, a housing, an enclosure, etc.) in which the camera may be housed and/or affixed. The bottom plate 200 may have a step-like (e.g., cascading) structure (e.g., ripples) formed on its surface. The steps of this structure may cause incident light to reflect or diffuse from surface of the bottom plate 200 in specific ways. The number (e.g., quantity), the shape, and/or the size of the steps may determine the reflection and diffusion characteristics of the bottom plate 200.

As an example, a light shield (e.g., a camera light shield) may include a back wall, a pair of side walls, and a bottom plate. The back wall may be a camera mount where a camera may be installed. The back wall may be disposed at a back of the camera light shield (e.g., in the direction facing the interior of the vehicle when the light shield is installed on an inner surface of a windshield of the vehicle). The back wall may have an aperture. When the camera is mounted on the light shield, the camera (e.g., a camera lens) may point through the aperture. Each of the pair of side walls may connect to each side (e.g., left and right sides) of the back wall at an obtuse angle so as to, for example, form a fan shape (e.g., a triangle or a trapezoid). The bottom plate may include a front edge and a back edge that are connected to a pair of side edges. The front edge, the back edge, and the side edges of the bottom plate may form a polygonal shape, such as a trapezoid. The bottom plate may share each side edge of the pair of side edges with a corresponding side wall of the pair of side walls. The back edge of the bottom plate may connect to the back wall. The bottom plate, the back wall, and/or the side walls may block or attenuate ambient light (e.g., stray light) from being incident on the camera through the aperture of the back wall. The front edge may be greater in length than the back edge, A cascading ripple texture (e.g., arc-shaped steps) may be formed on the bottom plate. The cascading ripple texture may include a plurality of arcs. The plurality of arcs may have a forward concavity (or backward convexity). The forward concavity may be toward the front edge and away from the aperture. Alternatively, the plurality of arcs may have a backward concavity (or front convexity).

Here, the bottom plate 200 may slope (e.g., gradually slope or decline) away from the top edge 210 and toward an outer edge (also referred to as an outer end or a second end) 220 disposed at the opposite side.

The polygonal shape may be a trapezoidal shape. However, the present disclosure is not limited thereto. The bottom edge (e.g., a base) of the polygon may be a straight line or a combination of angled straight lines, or have a curve.

In the above-described shape of the light shield, an amount of light, reflected from the bottom plate 200, that is introduced into the lens of the camera may vary according to the shape of the bottom plate 200. Thus, the shape of the bottom plate 200 may be one of the design factors of the light shield that influences the amount of light being introduced to the camera.

Therefore, the number of steps (A) of the bottom plate 200, a height (B) of each step, a horizontal shape (C) of each step, and/or a cross-sectional shape (D) of each step may be selected as primary design factors.

Each factor may be set to one of a predetermined (e.g., three) levels.

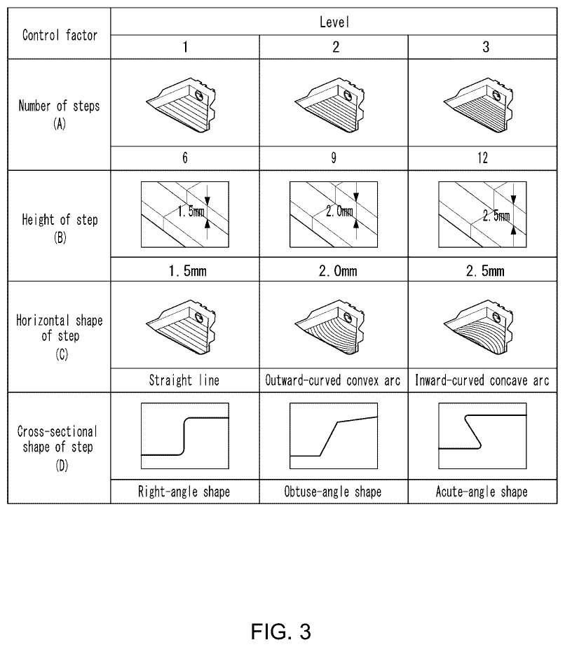

FIG. 3 is an example table for selecting a primary design factor. The levels for the number (or quantity) of steps (A) may include, for example, 6 (level 1), 9 (level 2), and 12 (level 3). However, other quantities of steps may be selected, and there may be fewer or more levels than three levels to be tested.

The maximum number may be set to, for example, 12, which may be the maximum number of manufacturable steps while satisfying all design conditions of the height (B) and the cross-sectional shape (D).

The levels of the height (B) may include, for example, 1.5 mm (level 1), 2.0 mm (level 2), and 2.5 mm (level 3). The levels of the horizontal shape (C) may include, for example, a straight line (level 1), an outward-curved (e.g., convex) arc (level 2), which may be a concave arc with respect to the camera mount, and an inward-curved (e.g., concave) arc (level 3), which may be a convex arc with respect to the camera mount. The levels of the cross-sectional shape (D) may include, for example, a right-angle shape (level 1) (e.g., a cross-section of each of the plurality of steps has lines meeting at a right angle), an obtuse-angle shape (level 2) (e.g., a cross-section of each of the plurality of steps has lines meeting at an obtuse angle), and an acute-angle shape (level 3) (e.g., a cross-section of each of the plurality of steps has lines meeting at an acute angle).

The primary design factors may have several combinations. However, in this example experiment, only nine combinations are selected and arranged in a vertical axis of the orthogonal array table.

This is because the DFSS robust method may analyze a trend by using only some combinations to find the improved (e.g., optimized) combination.

Secondary design factors may include glossy surfaces (level 1) and matte-finished surfaces (level 2) based on what material is used to treat the surfaces of the light shield, especially the surfaces of the plurality of steps.

This is because differences in light reflectance may occur depending on the surface treatment.

In this example experiment, only the primary design factors may be used for the combinations of factors in the orthogonal array table.

However, since there is a need for comparison in performances between glossy and matte treatment, the glossy and matte treatments may be adopted as secondary design factors, two orthogonal array tables are created, and average values thereof may be compared to determine a superior factor among the secondary design factors.

In some implementations of light shields, the number of steps may be 20, the height of each step may be 2.0 mm, the horizontal shape of each step may be an outward-curved convex arc, and the cross-sectional shape of each step may be a right-angle shape.

These particular implementations have been found to be prone to a significant amount of light reflection.

The light shield according to the present disclosure may have similar or same specifications as these implementations but with different factors applied as described above.

In step S200, a noise factor may be selected.

In this disclosure, an incident angle of a light source and an intensity of light of the light source may be selected as the noise factors.

The incident angle may influence a level (e.g., amount) of light reflection from the bottom plate 200 by influencing a light amount introduced into the lens by the reflection. The intensity of the light of the light source may influence a level (e.g., amount) of light reflection from the bottom plate 200.

The color temperature of the light may be another noise. factor. The influence of the color temperature on the amount of light reflection from the bottom plate 200 may be, for example, less than that of the incident angle or the intensity of light of the light source, but the color temperature may be used for comparative analysis of influence on light reflection.

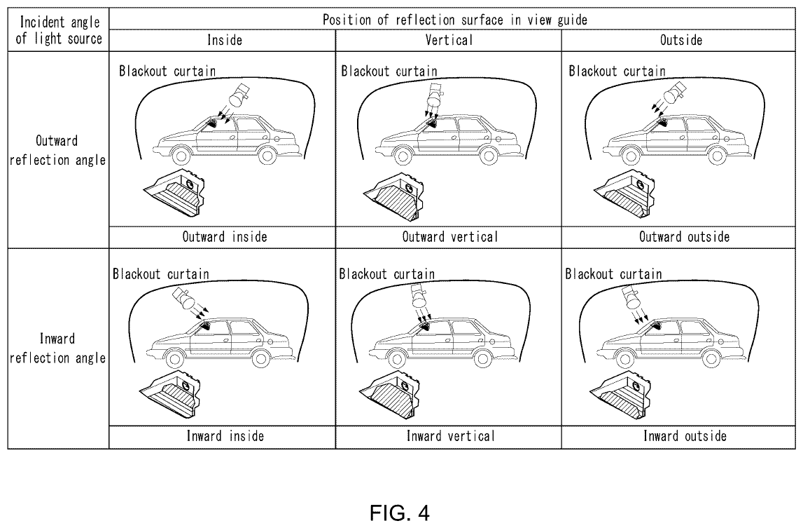

FIG. 4 is a view illustrating different levels of example incident angles of a light source as a noise factor. In case of the incident angle of the light source, the levels of the related noise factors may be classified as an outward reflection angle and an inward reflection angle according to the reflection angle and also classified into inner, vertical, and outer positions based on positions of a reflection surface in the light shield.

The reflection angle of light from a light source may be classified as an inward reflection angle if the light source is located in front of the position (e.g., location) of the light shield installed in the vehicle (e.g., the light source is located in front of the vehicle) and thus the light is reflected toward the camera. The reflection angle of light may be classified as an outward reflection angle if the light source is located above the vehicle (e.g., the light source is located behind the camera), and the light is reflected away from the camera.

The position of the reflection surface of the light shield may be classified as “inside” if the light reflects more off an inside portion (e.g., a top half) of the bottom plate 200 of the light shield. The position of the reflection surface of the light shield may be classified as “vertical” if the light reflects substantially equally off an entire surface of the bottom plate 200 of the light shield. The position of the reflection surface of the light shield may be classified as “outside” if the light reflects more off an outside portion (e.g., a bottom half) of the bottom plate 200 of the light shield.

In this case, all experiments may be conducted under darkroom conditions.

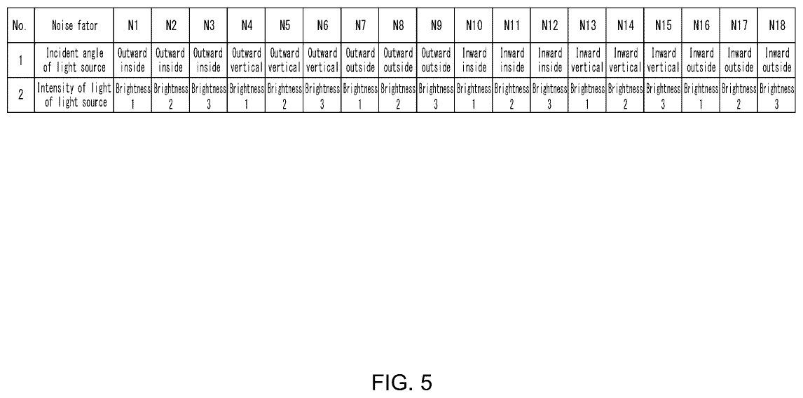

The levels of the light intensity of the light source may be classified as, for example, 2,000 1× (brightness level 1), 10,000 1× (brightness level 2), and 20,000 1× (brightness level 3). The incident angle of the light source and the light intensity of the light source, which are the noise factors, may represent a total of 18 combinations (N1 to N18) as shown in a table of FIG. 5.

The combinations of the noise factors may be arranged along a horizontal axis of the orthogonal array table, as shown in FIG. 5.

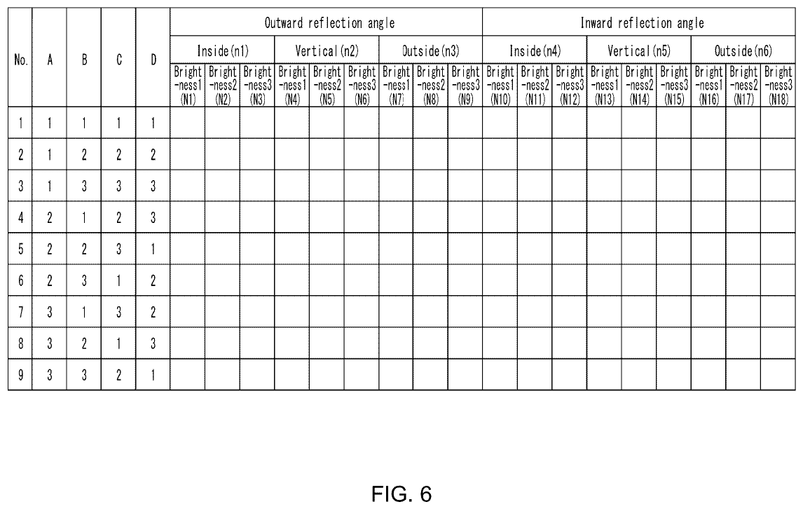

The orthogonal array table having the combinations of the primary design factors and the noise factors is shown in FIG. 6.

Numbers 1 through 3 listed on a left side of the table may represent the different levels (e.g., levels 1 through 3) of the primary design factors A through D.

For example, level 1 may represent that an experiment is conducted under light source conditions of 18 combinations, on a light shield having specifications: the number A of steps is 6, the height B of each step is 1.5 mm, the horizontal shape C of the stairs is a linear shape, and the cross-sectional shape D of the step is a right-angle shape.

In this example experiment, an L9 orthogonal array table may be used. A trend may be recognized by only 9 combinations through the L9 orthogonal array table, and an improved (e.g., optimized) combination may be defined.

A process of deriving an image analysis function capable of determining light reflection reduction in step S300 and analyzing an experimental result in step S400 will be described in detail.

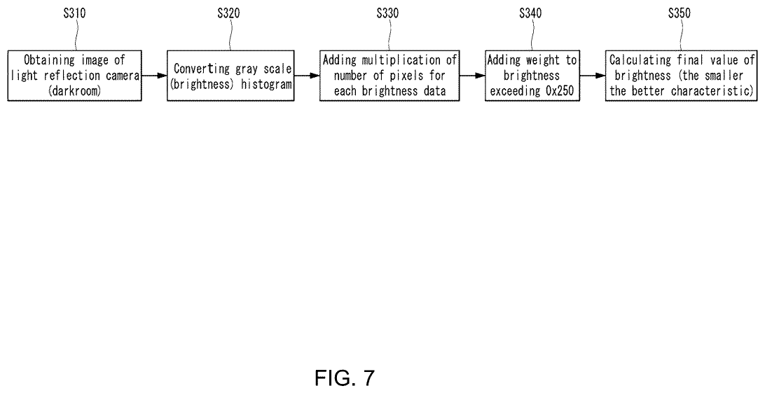

Referring to FIG. 7, images of a light reflection camera are obtained under darkroom conditions in step S310.

A light source may be installed, and a blackout curtain may be installed.

The light source is installed suitable to the combinations of the orthogonal array table such that the incident angle of the light source has an outward or inward reflection angle, and the reflection surface in the light shield reflects an inner, outer, or vertical position.

Also, the brightness of the light source may be set, for example, at three levels of 2,000 1×, 10,000 1×, and 20,000 1×, respectively, based on output.

Under the above-described combinations, the light source may have a total of 18 conditions.

Before or after the light source is installed, the blackout curtain may be installed to create a darkroom condition.

Light shield samples may be attached to a built-in camera.

The light shield samples may include, for example, a total 18 samples of nine glossy finish samples and 9 matte finish samples based on the orthogonal array table.

Here, 64 backup data for light shield-unmounted states, non-patterned samples, and mass-produced samples for each condition may be obtained in addition to 324 image samples (18×18) based on combinations of the angles and positions of the light source (18) and combinations of the light shield samples (18).

Accordingly, a total of 387 images are obtained.

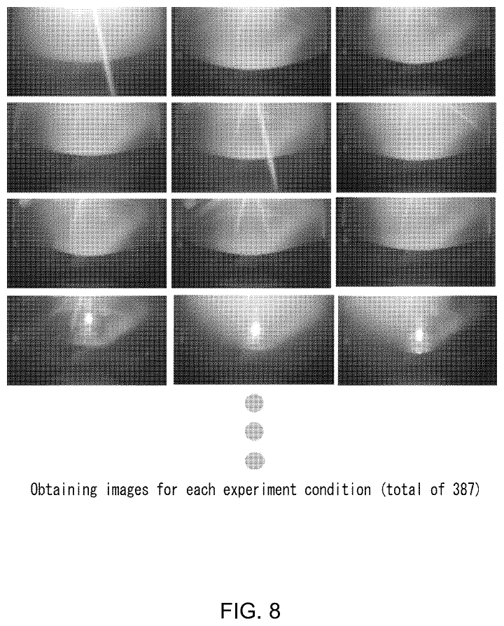

FIG. 8 is a view illustrating a portion of images obtained for each experiment condition.

A gray-scale (brightness) histogram transformation is performed based on the 387 obtained images for each image in step S320 of FIG. 7.

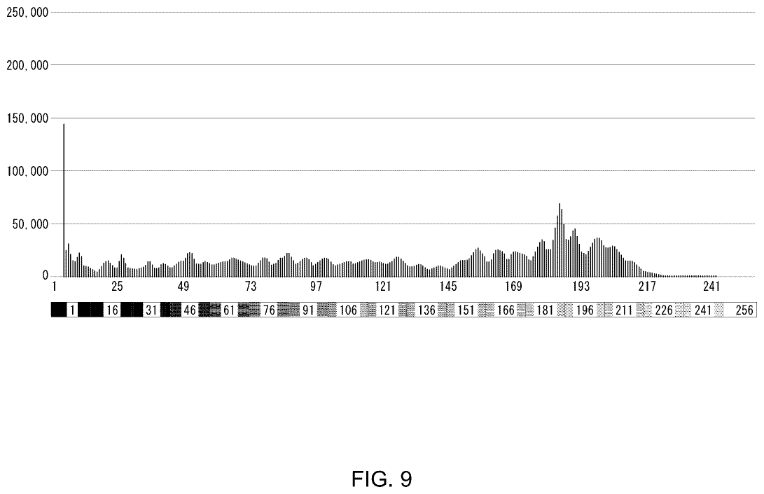

FIG. 9 is a histogram showing the number of pixels based on image brightness based on results thereof. Here, the total number of pixels is 2,560×1,440.

As shown in step S330 of FIG. 7, the image analysis function may add a weight for brightness exceeding 0×250 to a sum of multiplication of the number of pixels for each brightness data.

As shown in step S340 of FIG. 7, although a total combined value of brightness based on the histogram is extremely low, a weight index function is applied to exclude images with quality issues that exhibit a trend of concentration of brightness data above 0×250.

Brightness value for each image may be calculated by using result values of the histogram through the image analysis function as shown in step S350 of FIG. 7.

This may be expressed by a following equation.

$${\sum }_{x = 1}^{256} [ \{ x ( Brightness ) \times P ( x ) ( Pixel Count ) \} + 1 {0}^{x - 250} \times P ( x ) ]$$

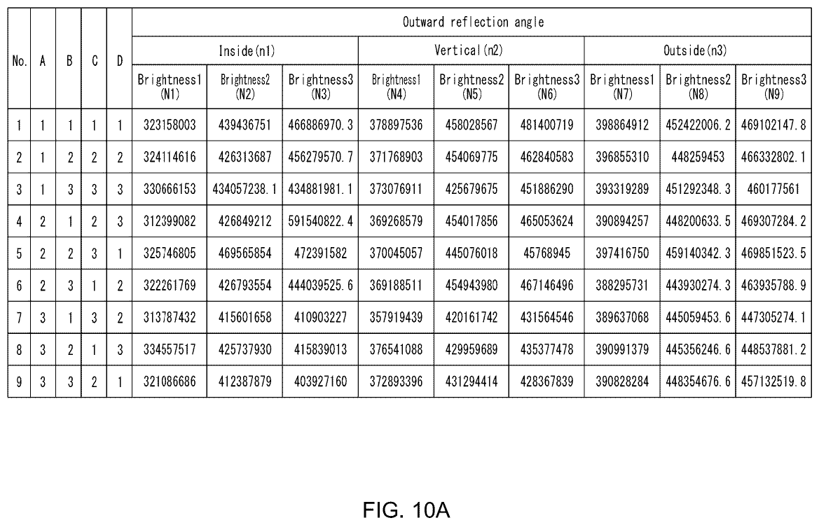

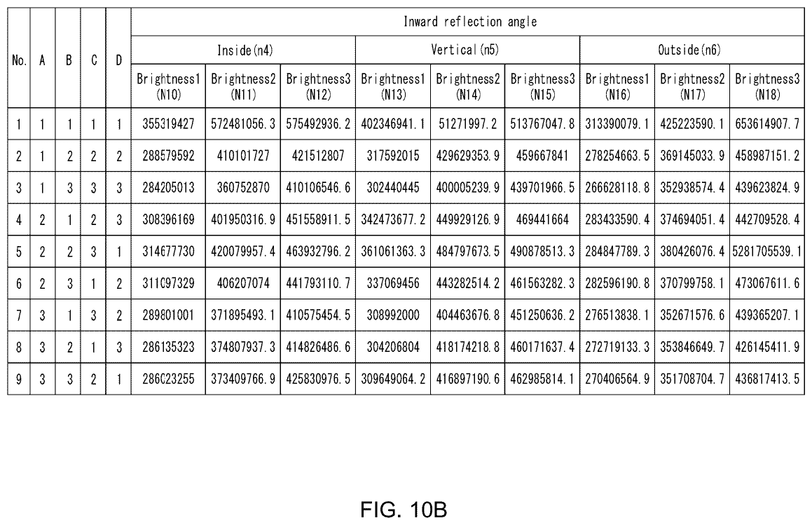

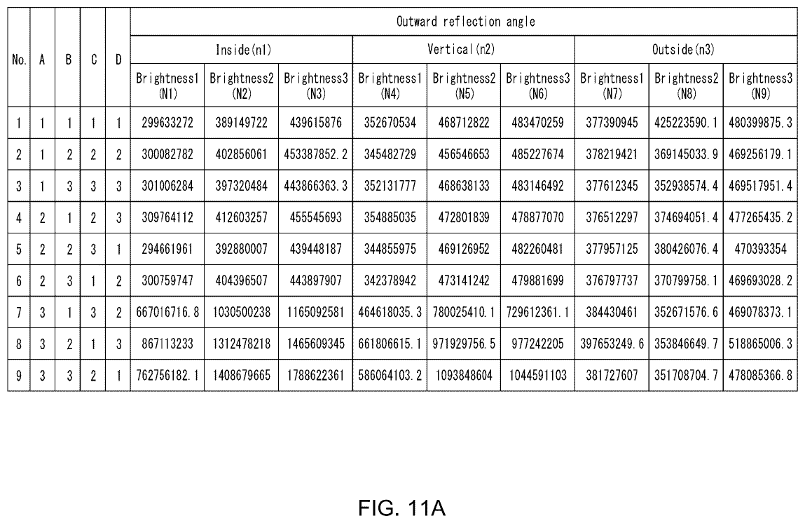

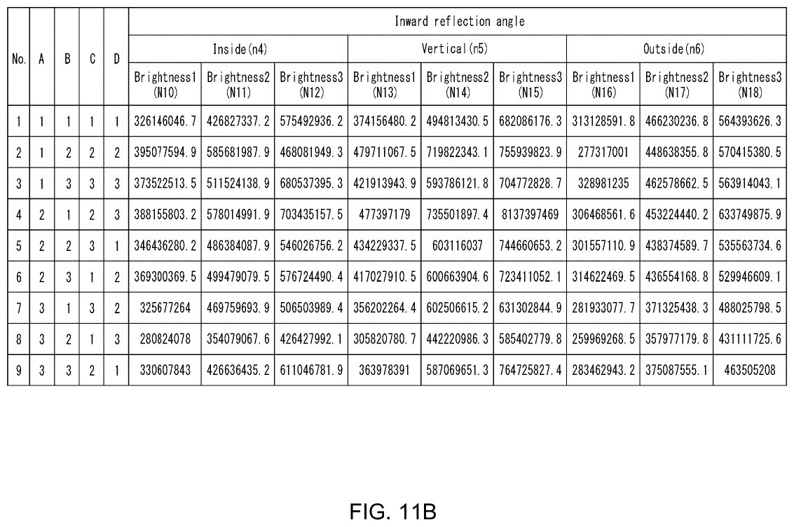

The brightness value for each image, which is calculated through the image analysis function, is shown in FIGS. 10A to 11B.

FIGS. 10A and 10B represent the orthogonal array tables showing the brightness values for each image of the matte finish light shield, and FIGS. 11A and 11B represent the orthogonal array tables showing the brightness values for each image of the glossy finish light shield.

Since the brightness values for each image are obtained through experiments conducted under the darkroom condition, lower brightness values caused by light reflection correspond to lower light reflectance.

That is, the brightness for each image has the smaller-the-better characteristic in which a lower value exhibits a better performance.

The experiment result is analyzed in step S400.

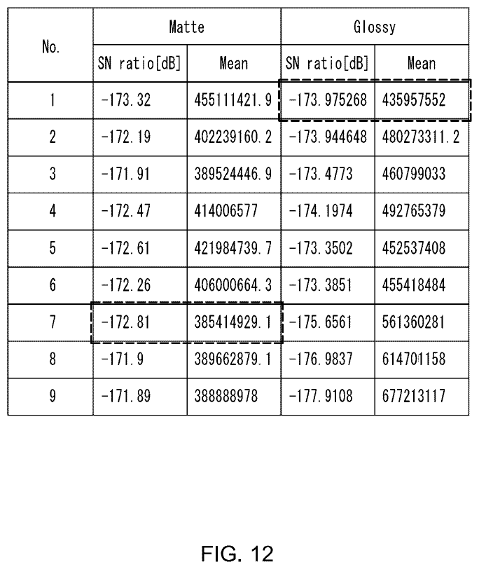

The experiment result is analyzed in five steps as shown in FIG. 12.

1) Deriving a signal-to-noise (SN ratio) and a mean for the secondary design factors (related to a surface material) in step S710

2) Selecting an improved (e.g., optimized) level among the secondary design factors in step S720

3) Analyzing interactions between the primary design factors using the orthogonal array table for a matte material in step S730

4) Deriving and analyzing the SN ratio and the mean of the primary design factors under a matte condition in step S740.

5) Analyzing influence of the primary design factors in detail under matte condition in step S750.

The SN ratio is a ratio of signal strength to noise strength, in which a higher value represents a better performance. The SN ratio for the smaller-the-better characteristic may be calculated using a following equation.

$$S N Ratio = - 10 log ( \frac{1}{n} {\sum }_{i = 1}^{n} {Y}_{i}^{2} )$$

Here, Yi denotes brightness values obtained from measured image data and n denotes a number of measured data.

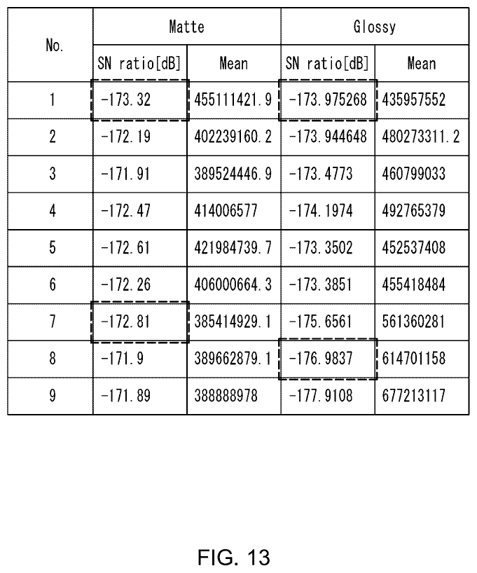

The SN ratios and the mean values for each condition, which are calculated using the above equation, are shown in FIG. 13.

Dotted boxes in the table represent a minimum value and a maximum value of the SN ratio for each material.

According to the above results, the SN ratio for matte material has a value of −173.32 dB to −171.81 dB, and the SN ratio for glossy material has a value of −177.91 dB to −172.98 dB.

Thus, since the matte material having a greater range of SN ratios is superior in terms of reduction in light reflection, the “matte” condition is selected as an improved (e.g., optimized) factor for the surface material.

The interactions between the primary design factors may be analyzed by using an interaction analysis tool for the results of the orthogonal array table based on the matte material.

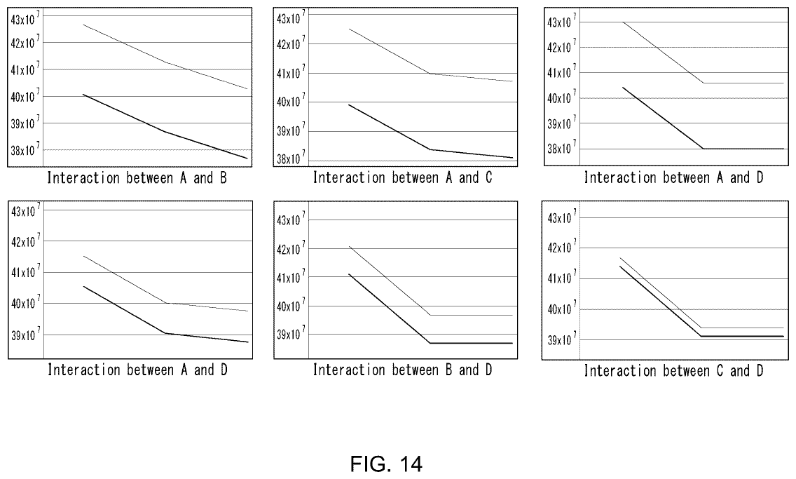

The results are shown in FIG. 14. According to the results, there is no interaction between the primary design factors related to the shape of the bottom plate 200, i.e. the number A of steps, and the height B, the horizontal shape C, and the cross-sectional shape D of each step.

The SN ratio and the mean value for each level of the primary design factors may be derived by using an automatic calculation tool for the results of the orthogonal array table based on the matte material.

This may be derived by using the SN ratio equation having the smaller-the-better characteristic as described above.

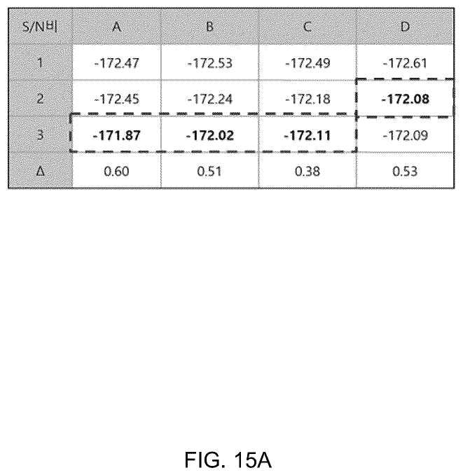

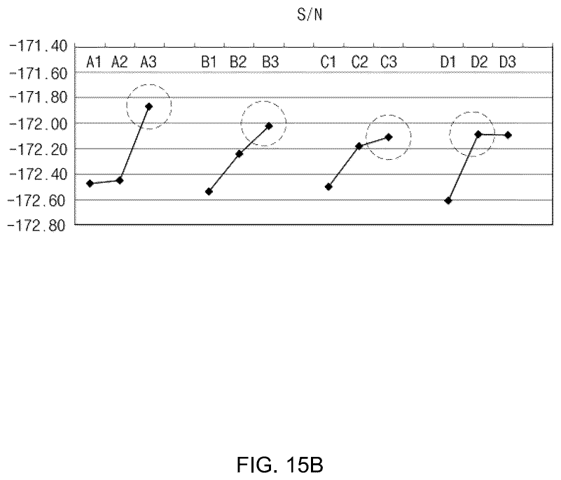

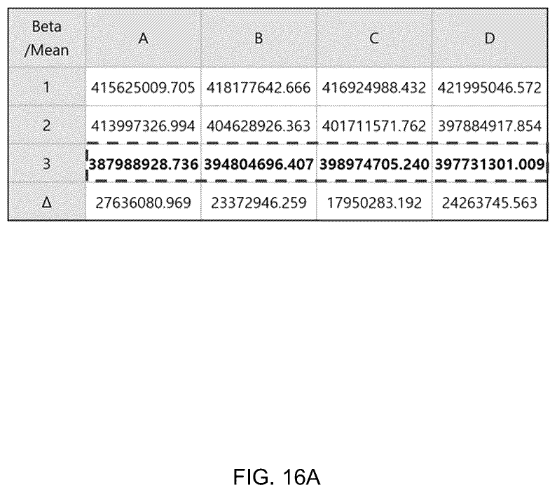

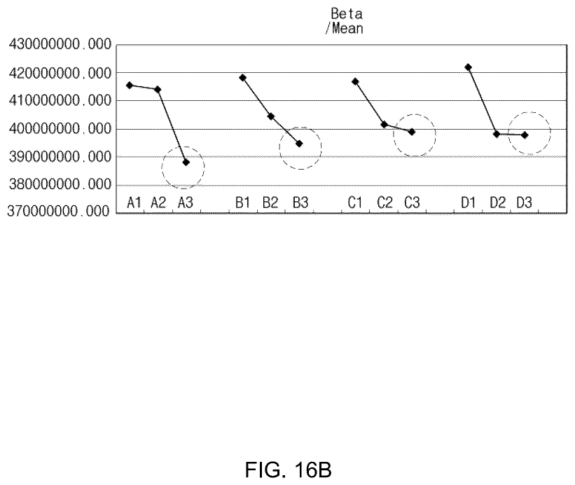

The result values are shown in FIGS. 15A and 16A and illustrated in graphs in FIGS. 15B and 16B.

Dotted boxes in the table and dotted circles in the graphs represent the improved (e.g., optimized) levels (a largest value for the S/N ratio and a smallest value for the mean value).

According to the above results, it may be known that factors A3, B3, and C3 have most superior performances based on the SN ratio and the mean value.

However, in case of factor D, D2 has a superior S/N ratio, while D3 has an excellent mean value. Thus, the improved (e.g., optimized) level of the factor D may be determined through additional analysis.

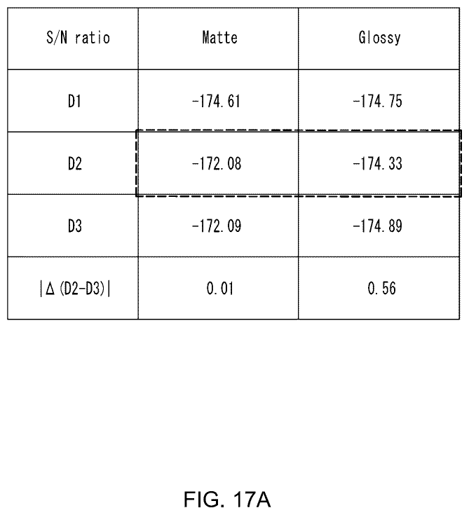

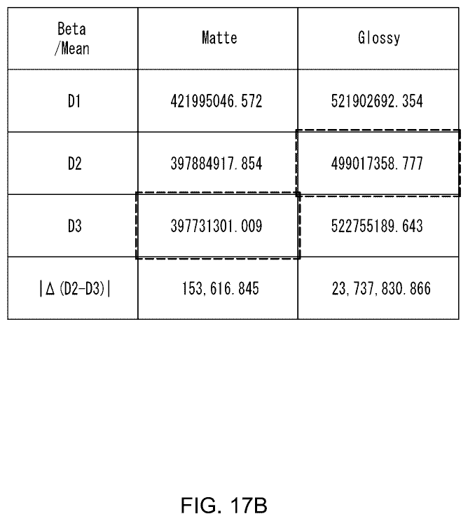

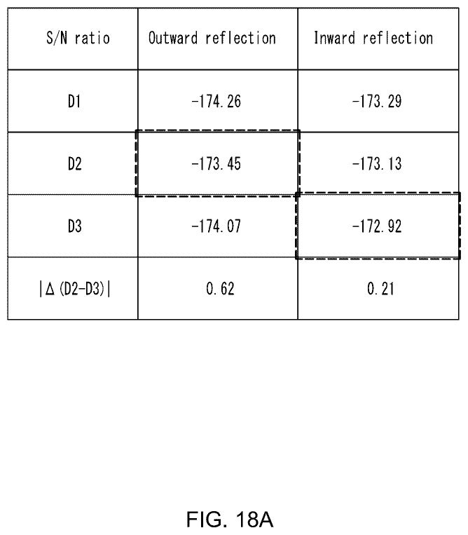

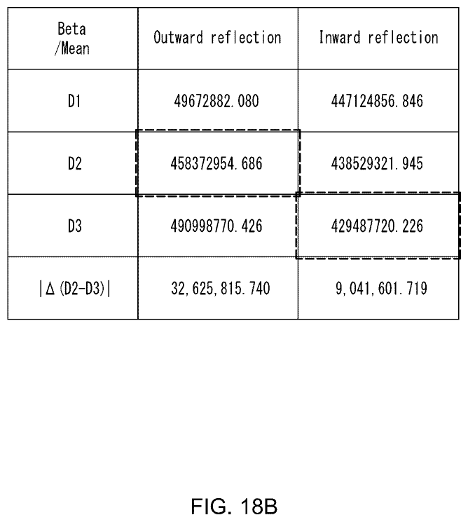

To this end, the S/N ratios and the mean values of factor D for matte and glossy materials are compared with each other (refer to FIGS. 17A and 17B), and the S/N ratios and the mean values under outward reflection angle conditions and inward reflection angle conditions are compared with each other (refer to FIGS. 18A and 18B).

Referring to FIGS. 17A and 17B, it may be known that a deviation between results of factors D2 and D3 based on the matte condition is insignificant.

Although D2 is slightly superior in noise robustness (S/N ratio), D3 is slightly superior in mean value.

On the other hand, under the glossy condition, it is known that the factor D2 exhibits a performance superior to the factor D3 (D2>D3).

Referring to FIGS. 18A and 18B, it may be observed that the factor D2 exhibits significantly superior performance compared to the factor D3 (D2>>D3) under the outward reflection condition, while the factor D3 exhibits slightly superior performance compared to the factor D2 (D2≤D3) under the inward reflection condition.

Additionally, when comparing complexity of sample manufacturing, the obtuse-angle shape D2 of the cross-sectional shape of each step is lower in manufacturing difficulty and has fewer constraints compared to the acute-angle shape D3.

When the above results are compared, the factor ‘D2’ is selected as the improved (e.g., optimized) factor because the factor D2 is less sensitivity to noise and easily manufactured while the factor D3 shows excessive deviations in performance according to the surface materials (matte or glossy) and light reflection angles.

As a result, the improved (e.g., optimized) levels of the primary design factors based on the experiment results correspond to A3 (number of steps: 12), B3 (height of step: 2.5 mm), C3 (horizontal shape of each step: inward-curved concave arc), and D2 (cross-sectional shape of each step: obtuse-angle shape), and the improved (e.g., optimized) level of the secondary design factor corresponds to the matte finish.

A combination of the above-described factors is referred to as an improved (e.g., optimized) sample 1.

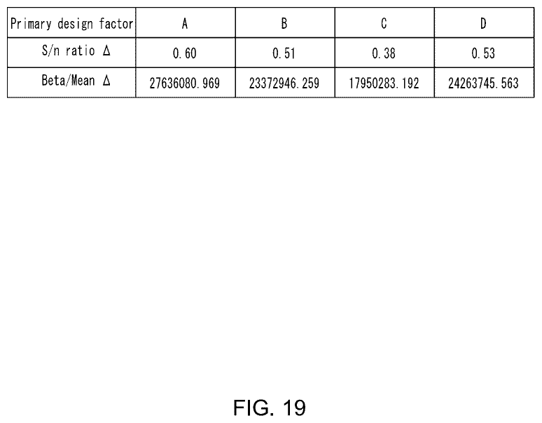

In addition, when FIG. 19 illustrating a deviation between the SN ratios and mean values of each primary design factor is analyzed to determine the primary design factor that exhibits greatest influence on the light reflection, factor A (the number of steps) having a greatest deviation exhibits greatest influence on the light reflection of the light shield.

Also, factors B (height of step) and D (cross-sectional shape of step) exhibit a similar level of influence on the light reflection of the light shield, while factor C (horizontal shape of step) exhibits lowest influence.

Referring to the SN ratio (refer to FIG. 15B) and the mean value (refer to FIG. 16B) of the factor A that exhibits greatest influence on the light reflection, it is observed that the performance improves as the number of steps increases.

Thus, a combination in which the number of factor A increases to 20 from the improved (e.g., optimized) sample 1 is selected as an improved (e.g., optimized) sample 2.

The 3 level of factor A is initially set to 12 because the maximum number of designable/manufacturable steps is restricted to 12 as the factor D (cross-sectional shape of step) includes the acute-angle shape. However, since the obtuse-angle shape is selected as an improved (e.g., optimized) level of factor D, the number of steps may be designed up to a maximum of 20. Thus, factor A in the improved (e.g., optimized) sample 2 is set to have the maximum manufacturable number of 20 steps.

In order to verify the performance of the improved (e.g., optimized) specifications, results according to the experiment conditions of the orthogonal array table is compared with results obtained by analyzing images photographed by mounting the light shield having corresponding specifications in a vehicle.

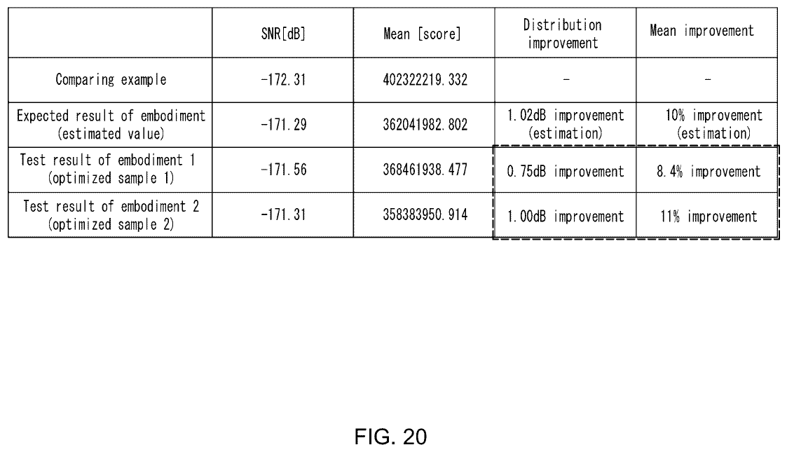

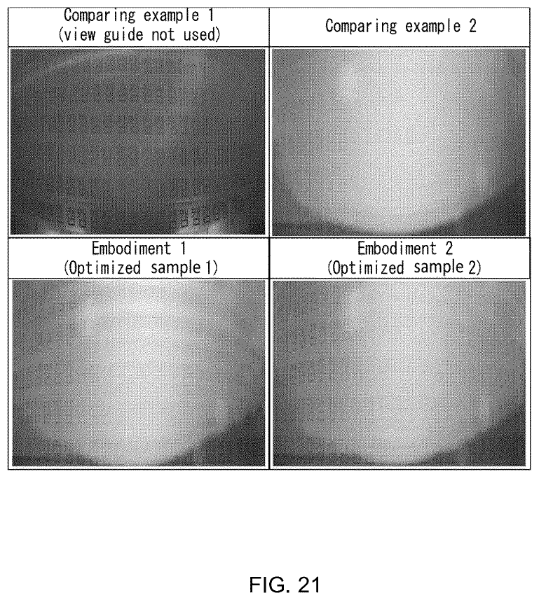

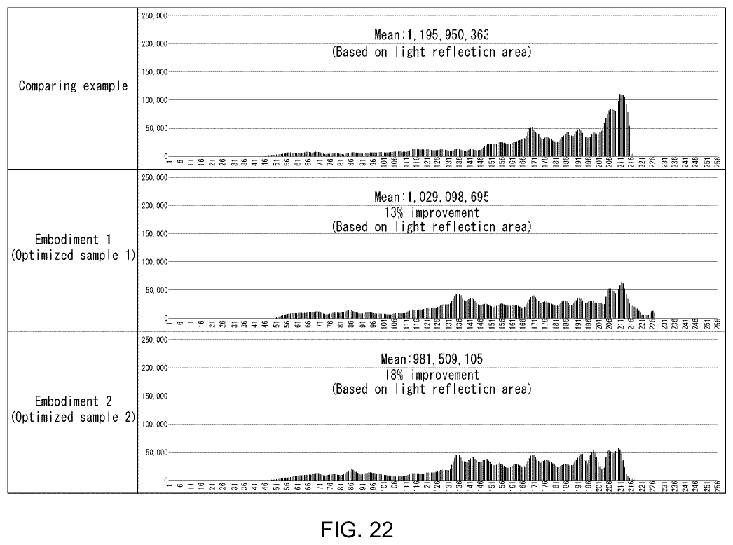

FIG. 20 is a table showing SN ratios and mean values obtained under experiment conditions (darkroom conditions) of the orthogonal array table of the improved (e.g., optimized) sample 1 and the improved (e.g., optimized) sample 2, FIG. 21 shows images photographed by a camera (e.g., a front camera) by mounting the light shield mounted on a vehicle using a mass-produced product, the improved (e.g., optimized) sample 1, and the improved (e.g., optimized) sample 2, and FIG. 22 shows histograms obtained from the images obtained in FIG. 21.

Referring to FIG. 20, it may be observed that the SN ratio exhibits an improvement of 0.75 dB for the improved (e.g., optimized) sample 1 and 1.00 dB for the improved (e.g., optimized) sample 2 compared to the mass-produced product, and the mean values exhibits an improvement of 8.4% for the improved (e.g., optimized) sample 1 and 11% for the improved (e.g., optimized) sample 2 compared to the mass-produced product.

It may be observed that expected results of the improved (e.g., optimized) product show improvements of 1.02 dB and 10% compared to the mass-produced product as estimated values.

Referring to FIG. 21, an image photographed by the front camera in a non-mounting state of the light shield is dark but clearly shows a word “CAM” over an entire image.

However, an image photographed by a camera to which the mass-produced light shield is mounted has a wide unreadable area at a central portion thereof.

It may be observed that the improved (e.g., optimized) sample 1 has an improved readable area compared to the mass-produced product, and the improved (e.g., optimized) sample 2 shows an improvement in reading the word “CAM” at the central portion compared to the improved (e.g., optimized) sample 1.

Referring to FIG. 22, in terms of the mean value of the histogram for the above-described images, the improved (e.g., optimized) sample 1 may have the mean value of 1,029,098,695 based on the light reflection area, which may exhibit 13% improvement compared to some implementations of a light shield that has the maximum value of 1,195,950,363 based on the light reflection area, and the improved (e.g., optimized) sample 1 has the mean value of 981,509,105 based on the light reflection area, which exhibit 18% improvement compared to some implementations of a light shield.

As a result, the improved (e.g., optimized) sample 2 improves the light reflection by 11% based on the experiment condition (darkroom) of the orthogonal array table and improves the light reflection by 18% based on a reproduction condition. Thus, it is determined that effectiveness validations on the improved (e.g., optimized) specifications of the light shield is completed.

In summary, for camera light shields for removing a dashboard glare phenomenon, undesired side effects may be observed, in which light from the sun or streetlights at specific angles is reflected off the surface of the light shield and incident into the lens to cause image blurring.

In order to reduce (e.g., minimize) these side effects, the pattern shapes and material of the surface of the light shield, which are designable, may be selected as the factors of the experiment. The DFSS experiment plan method based on the orthogonal array table to reduce (e.g., minimize) the light reflection is used to quantitatively analyze the image brightness data. Accordingly, the design combination of the surface patterns and materials of the improved (e.g., optimized) light shield capable of reducing (e.g., minimizing) the light reflection may be derived.

In the design specifications of the improved (e.g., optimized) light shield, which are derived based on the plan method of the present experiment, the material of the light shield is processed with a matte finish, the height of each step is 2.0 mm to 3.0 mm (preferably 2.5 mm), the number of steps is 12 to a maximum of 20, the horizontal shape of the step is the inward-curved concave arc, and the cross-sectional shape of the steps is the obtuse-angle shape.

The above-described five improved (e.g., optimized) design specifications exhibit deviations in light reflection level based on adjustment of levels of design factors and combination conditions thereof, and calculated by using excellent combinations exhibiting a greatest performance as a base of the experiment.

The improved (e.g., optimized) combination (number of steps is 20) is determined by a new combination with the improved (e.g., optimized) mean value and SN ratio, and in this case, the SN ratio is-171.31 dB, and the mean values is 358,383,950.914 points, which are final performances.

This combination may exhibit an improvement in light reflection of approximately 21% compared to a lowest-performance matte combination and an improvement of approximately 47% compared to a lowest-performance glossy combination.

As described above, the design values of the improved (e.g., optimized) light shield obtained through this experiment quantitatively may confirm reduction in light reflection performance, and an improvement effect may be checked through comparing images even by the naked eyes.

The light shield manufactured using the improved (e.g., optimized) design combination factors derived from this experiment may be mounted to a vehicle to significantly improve the light reflection limitations that are typical field issues. Also, the light shield may improve an image quality recorded by the built-in camera and secure the image robustness against external conditions to increase customer satisfaction.

A camera view guide may include: a camera mounting part; a bottom plate comprising a first end connected to a lower end of the camera mounting part; and a pair of side plates each connected to an inclined side of the bottom plate and a side portion of the camera mounting part, wherein the bottom plate is declined by a plurality of steps from the first end toward a second end disposed opposite to the first end.

A number of the plurality of steps may be 12 to 20.

Surfaces of the plurality of steps may be matte-finished.

Each step of the plurality of steps may have a height of 2.0 mm to 3.0 mm.

Each step of the plurality of steps may be formed in a shape of a convex arc with respect to the camera mounting part.

A cross-sectional shape of each step of the plurality of steps may be an obtuse-angle shape.

Surfaces of the plurality of steps may be matte-finished, and a number of the plurality of steps is 12 to 20, each step of the plurality of steps has a height of 2.0 mm to 3.0 mm and is in a shape of a convex arc with respect to the camera mounting part, and a cross-sectional shape of each step of the plurality of steps is an obtuse-angle shape.

A vehicle may include: a front camera; and a camera view guide mounted to the front camera, wherein the camera view guide comprises: a camera mounting part; a bottom plate comprising a first end connected to a lower end of the camera mounting part; and a pair of side plates each connected to an inclined side of the bottom plate and a side portion of the camera mounting part, wherein the bottom plate is declined by a plurality of steps from the first end toward a second end disposed opposite to the first end.

A number of the plurality of steps may be 12 to 20.

Surfaces of the plurality of steps may be matte-finished.

Each step of the plurality of steps may have a height of 2.0 mm to 3.0 mm.

Each step of the plurality of steps may be formed in a shape of a convex arc with respect to the camera mounting part.

A cross-sectional shape of each step of the plurality of steps may be an obtuse-angle shape.

A vehicle includes: a front camera; and a camera view guide mounted to the front camera, wherein the camera view guide comprises: a camera mounting part; a bottom plate having a shape of a polygon having an upper side connected to a lower end of the camera mounting part; and a pair of side plates which are connected to an inclined side of the polygon of the bottom plate and a side portion of the camera mounting part, respectively, wherein the bottom plate is inclined downward while forming stairs in a direction from an inner end connected to the camera mounting part toward an outer end disposed opposite to the inner end, surfaces of the plurality of steps is matte-finished, and wherein a number of the plurality of steps is 12 to 20, each step of the plurality of steps has a height of 2.0 mm to 3.0 mm and is in a shape of a convex arc with respect to the camera mounting part, and a cross-sectional shape of each step of the plurality of steps is an obtuse-angle shape.

The present disclosure proposes an improved (e.g., optimized) structure of the light shield, which may reduce (e.g., minimize) the light reflection.

Also, a light shield according to the present disclosure may exhibit 10% or more reduction in light reflection compared to at least some implementations.

Also, a light shield according to the present disclosure may reduce (e.g., minimize) the reflected light from being incident into the lens to improve the robustness of the image quality of the built-in camera.

The light shield may be designed with the improved (e.g., optimized) conditions based on the experiment results that consider secondary re-reflection from the windshield glass to secure the improved (e.g., optimized) performance.

Although example embodiments of the present disclosure have been described above, these are merely illustrative examples and should not be construed as limiting the present disclosure to these example embodiments.

What is claimed is:

1. A camera light shield comprising:
a camera mount;
a bottom plate comprising a top edge connected to a lower portion of the camera mount, wherein the bottom plate slopes down from the top edge to a bottom edge of the bottom plate, and wherein a plurality of steps are formed on a sloped surface of the bottom plate; and
a pair of side plates each connected to the bottom plate and a side portion of the camera mount.

2. The camera light shield of claim 1, wherein a quantity of the plurality of steps is between 12 and 20.

3. The camera light shield of claim 1, wherein surfaces of the plurality of steps are matte-finished.

4. The camera light shield of claim 1, wherein each step of the plurality of steps has a height between 2.0 mm and 3.0 mm.

5. The camera light shield of claim 1, wherein each step of the plurality of steps is formed in a shape of a convex arc with respect to the camera mount.

6. The camera light shield of claim 1, wherein a cross-section of each step of the plurality of steps comprises lines meeting at an obtuse angle.

7. The camera light shield of claim 1, wherein surfaces of the plurality of steps is matte-finished,
wherein a quantity of the plurality of steps is between 12 and 20,
wherein each step of the plurality of steps has a height between 2.0 mm and 3.0 mm,
wherein each step of the plurality of steps is formed in a shape of a convex arc with respect to the camera mount, and
wherein a cross-section of each step of the plurality of steps comprises lines meeting at an obtuse angle.

8. The camera light shield of claim 1, wherein the camera light shield comprises a back wall disposed at a back of the camera light shield, the back wall having an aperture therethrough,
wherein the bottom plate comprises a front edge and a back edge that are connected to a pair of side edges,
wherein the bottom plate shares each side edge of the pair of side edges with a corresponding side wall of a pair of side walls,
wherein each side wall of the pair of side walls connects to a different side of the back wall at an obtuse angle,
wherein the back edge of the bottom plate connects to the back wall,
wherein the front edge is greater in length than the back edge,
wherein a cascading ripple texture is formed on the bottom plate, and
wherein the cascading ripple texture comprises a plurality of arcs having a forward concavity toward the front edge and away from the aperture.

9. A vehicle comprising:
a camera light shield comprising:
a camera mount;
a bottom plate comprising a top edge connected to a lower portion of the camera mount, wherein the bottom plate slopes down from the top edge to a bottom edge of the bottom plate, and wherein a plurality of steps are formed on a sloped surface of the bottom plate; and
a pair of side plates each connected to the bottom plate and a side portion of the camera mount; and
a camera mounted at the camera mount of the camera light shield.

10. The vehicle of claim 9, wherein a quantity of the plurality of steps is between 12 and 20.

11. The vehicle of claim 9, wherein surfaces of the plurality of steps are matte-finished.

12. The vehicle of claim 9, wherein each step of the plurality of steps has a height between 2.0 mm and 3.0 mm.

13. The vehicle of claim 9, wherein each step of the plurality of steps is formed in a shape of a convex arc with respect to the camera mount.

14. The vehicle of claim 9, wherein a cross-section of each step of the plurality of steps comprises lines meeting at an obtuse angle.

15. The vehicle of claim 9, wherein the camera light shield comprises a back wall disposed at a back of the camera light shield, the back wall having an aperture therethrough,
wherein the bottom plate comprises a front edge and a back edge that are connected to a pair of side edges,
wherein the bottom plate shares each side edge of the pair of side edges with a corresponding side wall of a pair of side walls,
wherein each side wall of the pair of side walls connects to a different side of the back wall at an obtuse angle,
wherein the back edge of the bottom plate connects to the back wall,
wherein the front edge is greater in length than the back edge,
wherein a cascading ripple texture is formed on the bottom plate, and
wherein the cascading ripple texture comprises a plurality of arcs having a forward concavity toward the front edge and away from the aperture.

16. A camera light shield comprising:
a back wall disposed at a back of the camera light shield, the back wall having an aperture therethrough;
a pair of side walls, each side wall of the pair of side walls connecting to a different side of the back wall at an obtuse angle; and
a bottom plate comprising a front edge and a back edge that are connected to a pair of side edges,
wherein the bottom plate shares each side edge of the pair of side edges with a corresponding side wall of the pair of side walls,
wherein the back edge of the bottom plate connects to the back wall,
wherein the front edge is greater in length than the back edge,
wherein a cascading ripple texture is formed on the bottom plate, and
wherein the cascading ripple texture comprises a plurality of arcs having a forward concavity toward the front edge and away from the aperture.
